(19) United States
(12) Patent Application Publication
(10) Pub. No.: US 2013/0164565 A1
(43) Pub. Date: Jun. 27, 2013

(54) SYSTEM AND METHOD FOR OPERATING A DISTRIBUTED ENERGY STORAGE SYSTEM WITH MULTIPLE BUSES

(71) Applicant: Herman Lucas Norbert WIEGMAN, Niskayuna, NY (US)

(72) Inventor: Herman Lucas Norbert WIEGMAN, Niskayuna, NY (US)

(21) Appl. No.: 13/334,728

(22) Filed: Dec. 22, 2011

(51) Int. Cl. H01M 10/42; H01M 2/00

(52) U.S. Cl. 429/7; 429/50; 429/61

(57) ABSTRACT

Systems and methods for transferring energy between segments of energy storage elements. At least one defined characteristics of each of two or more energy storage segments is monitored by at least one monitoring device, and a difference in at least one of the defined characteristics is determined between the two or more energy storage segments. Based on the determined difference, a control device commands a balancing circuit to transfer energy from at least one of the two or more energy storage segments to at least another of the two or more energy storage segments.

### BACKGROUND

1. Technical Field

Embodiments of the subject matter disclosed herein relate to energy storage systems. Other embodiments relate to systems and methods for operating an energy storage system.

2. Discussion of Art

For an array of energy storage elements, balancing circuits traditionally use voltage based feedback to force a balancing current to steer the voltage imbalance between two adjacent energy storage elements back toward zero. This either necessitates a very large power rating for the balancing circuit to attempt to compensate for large voltage imbalances, or results in a set of energy storage elements that are not well balanced on their charge states, or energy states, due to a weak correlation between open circuit voltage and charge state.

It would therefore be desirable to develop a system and method having control features that provide a more intelligent and useful balancing of energy storage elements.

### BRIEF DESCRIPTION

In one embodiment, a method for transferring energy between energy storage elements is provided. At least one defined characteristic of each of two or more energy storage segments electrically connected in series is monitored. A difference in at least one of the defined characteristics between the two or more energy storage segments is determined Energy is transferred from at least one of the two or more energy storage segments to at least another of the two or more energy storage segments based on the determined difference.

In one embodiment, a system for transferring energy between segments of energy storage elements is provided. Two or more energy storage segments are provided which are electrically connected in series. At least one monitoring device is provided and is configured to monitor at least one defined characteristic of each of the two or more energy storage segments. At least one control device is provided which is operatively connected to the at least one monitoring device. The control device is configured to generate at least one control signal representative of a determined difference in at least one of the defined characteristics between the two or more energy storage segments. At least one balancing circuit is provided which is operatively connected to the at least one control device and the two or more energy storage segments. The balancing circuit is configured to transfer energy from at least one of the two or more energy storage segments to at least another of the two or more energy storage segments in response to the at least one control signal. As used herein, the terms “transfer energy”, “energy transfer”, “transfer of energy”, and the like refer to the transfer of charge (e.g., via an electrical current) from one energy storage segment to another.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Reference is made to the accompanying drawings in which particular embodiments of the invention are illustrated as described in more detail in the description below, in which:

FIG. 1 is an illustration of a first exemplary embodiment of a system for implementing methods of transferring energy between segments of energy storage elements;

FIG. 2 is an illustration of a second exemplary embodiment of a system for implementing methods of transferring energy between segments of energy storage elements;

FIG. 3 is an illustration of a third exemplary embodiment of a system for implementing methods of transferring energy between segments of energy storage elements;

FIG. 4 is a flowchart of an exemplary embodiment of a method of transferring energy between segments of energy storage elements using, for example, one of the systems of FIGS. 1-3;

FIG. 5 provides a graph illustrating how the recharge state of resistance (SOR) of an energy storage segment may change as a function of charge returned, as well as age, of the energy storage segment; and

FIG. 6 provides a graph illustrating an exemplary embodiment of a cyclical charge sustaining methodology for a system, having energy storage segments, based on the recharge state-of-resistance (SOR) characteristics of FIG. 5.

### DETAILED DESCRIPTION

Embodiments of the present invention relate to systems and methods of balancing and operating an energy storage system. Energy storage elements are assumed to be non-identical or in need of some form of balancing due to normal use, aging mechanisms, or contingency operations where some of the energy storage elements may have been removed or refreshed during normal service.

Embodiments of the present invention provide a control over a balancing circuit to achieve successful operation of a segmented energy storage system over various modes of operation. Embodiments provide for the monitoring of one or more defined characteristics of two or more energy storage elements and controlling the balancing circuit based on the defined characteristics to bias the flow of balancing charge between the two or more energy storage elements.

With reference to the drawings, like reference numerals designate identical or corresponding parts throughout the several views. However, the inclusion of like elements in different views does not mean a given embodiment necessarily includes such elements or that all embodiments of the invention include such elements.

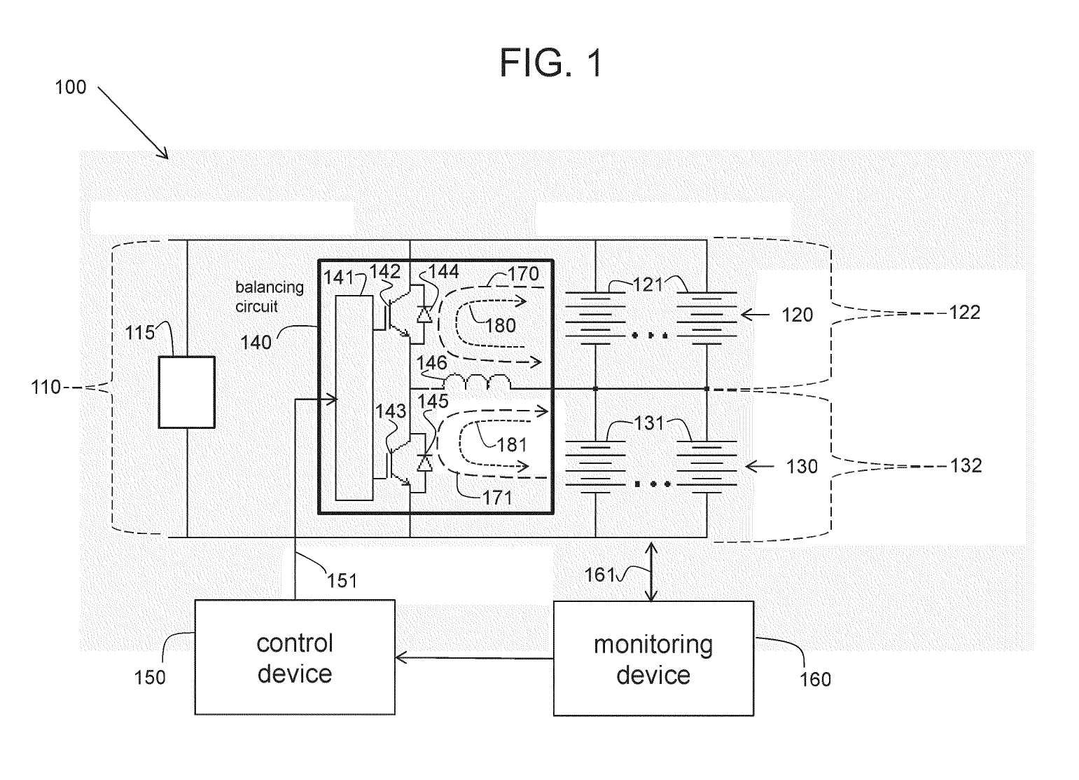

FIG. 1 is an illustration of a first exemplary embodiment of a system 100 for implementing methods of transferring energy between segments of energy storage elements. The system 100 includes a DC bus 110 for providing energy to one or more electrically driven DC loads 115. For example, the system 100 may be used to provide energy to a motor of an electric vehicle or to provide energy for a utility application.

The system 100 also includes a first energy storage segment 120 and a second energy storage segment 130. The first energy storage segment 120 is electrically connected in series with the second energy storage segment 130. The first energy storage segment 120 includes a plurality of energy storage elements 121 (e.g., electrochemical batteries, modules, or cells) electrically connected in parallel. The second energy storage segment 130 includes a plurality of energy storage elements 131 (e.g., electrochemical batteries, modules, or cells) electrically connected in parallel. In accordance with various other embodiments of the present invention, the plurality of energy storage elements 121 may instead be electrically connected in series or some combination of series and parallel. Similarly, the plurality of energy storage elements 131 may instead be electrically connected in series or some combination of series and parallel. Each energy storage segment 120 and 130 is electrically connected to an intermediate DC bus 122 and 132, respectively. As used herein, the term “energy storage segment” may refer to one energy storage element, or two or more energy storage elements connected in parallel, series, or some combination thereof.

The system 100 further includes a balancing circuit 140 electrically connected between the DC bus 110 and the intermediate DC buses 122 and 132. The balancing circuit (BC) 140 includes a control signal manager 141 operatively connected to a first electrical switch 142 (e.g., a power switching transistor) and a second electrical switch 143 (e.g., a power switching transistor). A first diode 144 is electrically connected across the first electrical switch 142, and a second diode 145 is electrically connected across the second electrical switch 143. The BC 140 also includes an inductor or choke 146 electrically connected between the two electrical switches 142 and 143 and the intermediate DC buses 122 and 132. Other configurations of balancing circuits are possible as well, in accordance with various other embodiments.

In accordance with various embodiments of the present invention, a power rating of the BC 140 may be reduced by pro-actively making adjustments to the energy storage segments over a period of time. Furthermore, the size of the energy storage elements may be reduced or more optimally sized because the BC 140 is configured to compensate for nominal energy storage segment aging such as, for example, capacity loss or resistance rise.

The system 100 includes a control device 150 operatively connected to the control signal manager 141 of the BC 140. The control device 150 commands the BC 140 to transfer energy from the first energy storage segment 120 to the second energy storage segment 130, or vice versa, in a controlled manner as described later herein. The system 100 also includes a monitoring device 160 operatively connected between the control device 150 and the energy storage segments 120 and 130. The monitoring device 160 monitors one or more defined characteristics of the first energy storage segment 120 and the second energy storage segment 130 as described later herein. In accordance with alternate embodiments, the monitoring device 160 may monitor defined characteristics of each of the energy storage elements 121 and 131, or subsets thereof. The monitoring device 160 may be, for example, a voltage monitoring device, a current monitoring device, a temperature monitoring device, or some combination thereof. Other types of monitoring devices are possible as well, in accordance with various embodiments.

During operation, energy can be transferred from the first energy storage segment 120 to the second energy storage segment 130 via the BC 140 where current flows through the system 100 in the direction of the dashed arrows 170 and 171. Similarly, energy can be transferred from the second energy storage segment 130 to the first energy storage segment 120 via the BC 140 where current flows through the system 100 in the direction of the dotted arrows 180 and 181.

For example, when energy is to be transferred from the first energy storage segment 120 to the second energy storage segment 130, the controller 150 commands the control signal manager 141 to turn on the first electrical switch 142 and turn off the second electrical switch 143. As a result, current flows in the direction 170 from the first energy storage segment 120, through the switch 142, into the inductor 146 where energy is stored. After a time, the controller 150 commands the control signal manager 141 to turn off the first electrical switch 141, and the energy stored in the inductor 146 reaches a maximum. Because the current through the inductor must flow continuously, the diode 145 across switch 143 is forward biased and the current flows in the direction 171 and transfers energy stored in the inductor 146 to the second energy storage segment 130. The process is referred to as inductive charge transfer. Alternatively, a similar process of capacitive charge transfer may be employed, where a capacitor is used to temporarily store the energy to be transferred instead of an inductor. However, the capacitive charge transfer process tends to be more lossy. Also, other alternative embodiments may employ pulse width modulation techniques or other current regulator techniques.

Similarly, when energy is to be transferred from the second energy storage segment 130 to the first energy storage segment 120, the controller 150 commands the control signal manager 141 to turn on the second electrical switch 143 and turn off the first electrical switch 142. As a result, current flows in the direction 181 from the second energy storage segment 130, through the inductor 146 where energy is stored, and through the switch 143. After a time, the controller 150 commands the control signal manager 141 to turn off the second electrical switch 143, and the energy stored in the inductor 146 reaches a maximum. Because the current through the inductor must flow continuously, the diode 144 across switch 142 is forward biased and the current flows in the direction 180 and transfers energy stored in the inductor 146 to the first energy storage segment 120.

In general, when energy is to be transferred, the BC 140 is operated in a cyclic manner (e.g., a pulsed manner or an AC manner). The switch (142 or 143), corresponding to an energy storage segment (120 or 130) that is to transfer energy to the other energy storage segment, is cyclically turned on and off (e.g., under control of the control device 150) to repeatedly allow energy to be stored/transferred to/from the inductor 146. The resulting applied bias currents and time duration of application is a function of the intended operation. The cyclic energy transfer process is continued until it is determined by the control device 150 that the balancing process is complete, in accordance with a defined completion criteria, as discussed later herein. In accordance with an alternate embodiment, the controller 150 may simply determine what the energy transfer should be, and the control signal manager 141 may determine the particulars of the high frequency switching. Other distributions of control functionality between the controller 150 and the control signal manager 141 are possible as well, in accordance with other alternate embodiments.

In accordance with various embodiments of the present invention, the monitoring device 160 may monitor one or more defined characteristics 161 of each of the energy storage segments 120 and 130. For example, the defined characteristics may include a state-of-charge (SOC), a state-of-resistance (SOR), a state-of-energy (SOE), a capacity (charge delivery capability), an energy (total stored energy), and/or a temperature, voltages, and/or currents of each of the energy storage segments 120 and 130. The transferring of energy from one energy storage segment to another is based on one or more of the defined characteristics. For example, the difference in SOC may be uniquely used to determine how to transfer charge between the two energy storage segments. However, for example, if the temperature of a transferring energy storage segment exceeds a preset threshold, the transferring of energy may be modified or completely stopped.

The control device 150 includes a control balancing algorithm (e.g., a software implementation) or a control balancing logic (e.g., a hardware implementation) to receive the monitored characteristics (or some derivation thereof) from the monitoring device 160 and generate control command signals 151 in response to the monitored characteristics as is discussed in more detail later herein. The control device 150 may be a processor-based device that runs software instructions (e.g., a digital signal processor (DSP), or microcontroller), or a logic circuit device (e.g., a programmable logic array) that performs functions in hardware, for example.

Other types of control devices are possible as well (e.g., combinations of software and hardware logic), in accordance with various other embodiments of the present invention. For example, in accordance with an alternate embodiment, the control balancing algorithm may be distributed between the various energy storage segments (e.g., distributed between various battery management systems associated with the energy storage segments) providing non-centralized decision making.

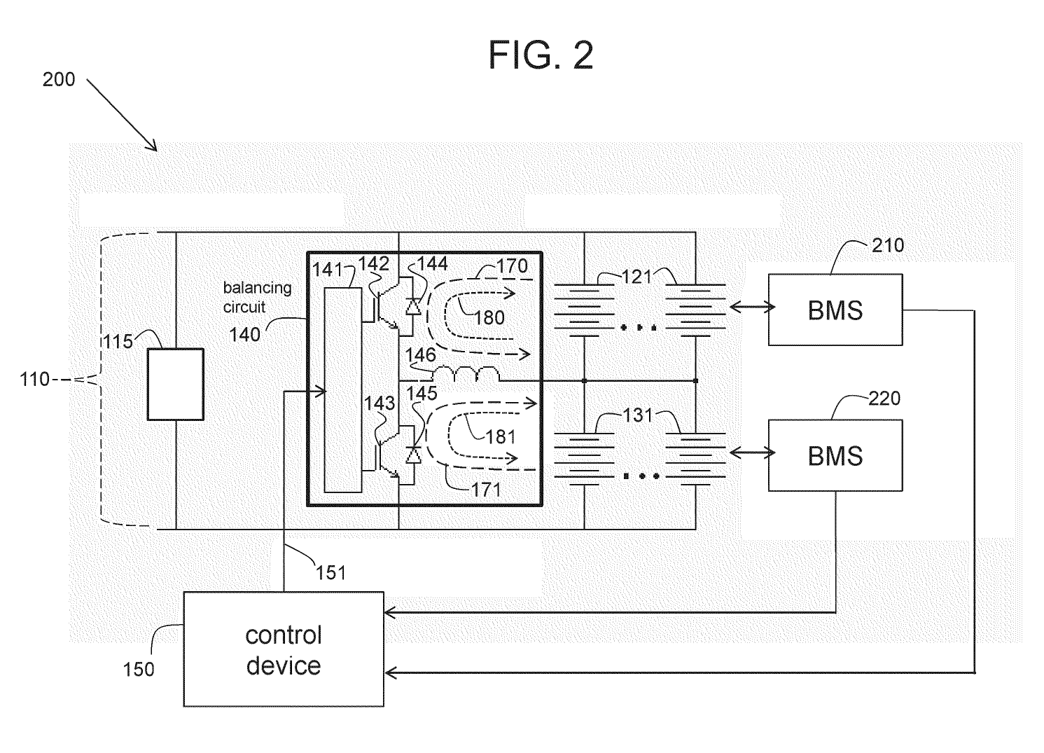

FIG. 2 is an illustration of a second exemplary embodiment of a system 200 for implementing methods of transferring energy between segments of energy storage elements. The system 200 is similar to the system 100 of FIG. 1 except that the monitoring device 160 of FIG. 1 is replaced with two (first and second) battery management systems (BMS) 210 and 220, one BMS for each energy storage segment. The first BMS 210 monitors energy storage characteristics of the first energy storage segment 120 and provides the monitored information (or some derivation thereof) to the control device 150. Similarly, the second BMS 220 monitors energy storage characteristics of the second energy storage segment 130 and provides the monitored information (or some derivation thereof) to the control device 150. The BMS's 210 and 220 may perform other functions as well, which are known in the art with respect to BMS's, in accordance with various embodiments.

In accordance with other various embodiments, each energy storage element 121 and 131 may have its own BMS which monitors and reports defined storage characteristics to the control device. Other monitoring/control device configurations and architectures are possible as well, in accordance with various other embodiments of the present invention.

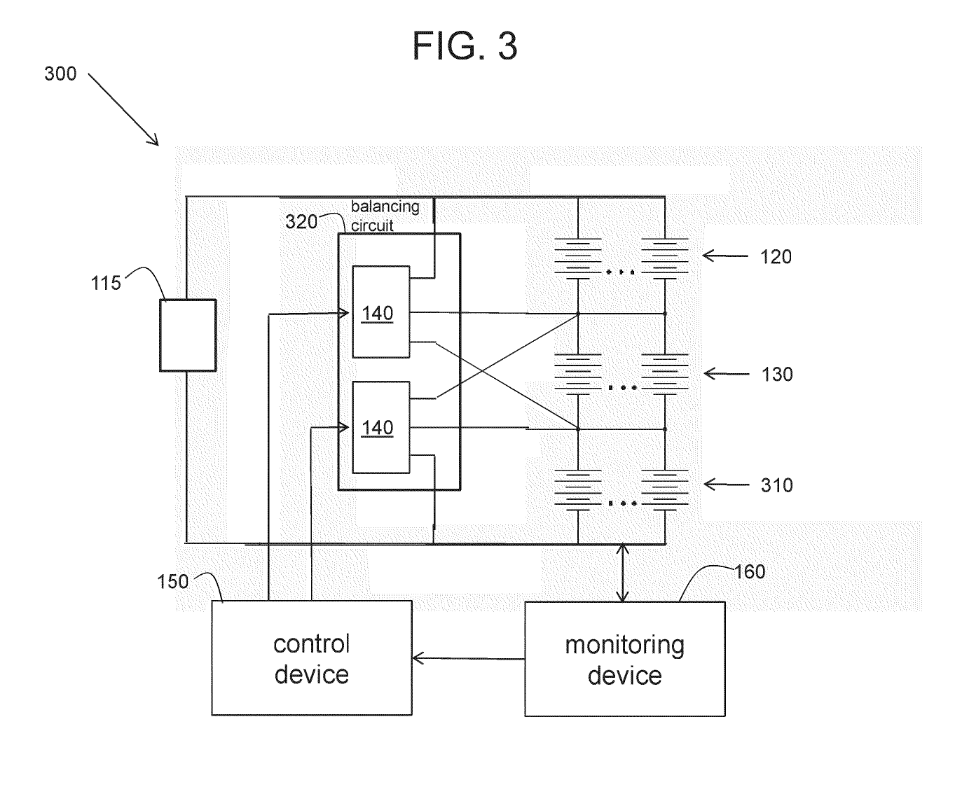

FIG. 3 is an illustration of a third exemplary embodiment of a system 300 for implementing methods of transferring energy between segments of energy storage elements. The system 300 is similar to the system 100 of FIG. 1. However, the system 300 is expanded to include a third energy storage segment 310 and a corresponding expanded balancing circuit (BC) 320. In the system 300, energy can be transferred between adjacent energy storage segments. The circuitry of the balancing circuit 140 is used in a dual configuration in the balancing circuit 320 to accomplish the transfer of energy, in accordance with an embodiment.

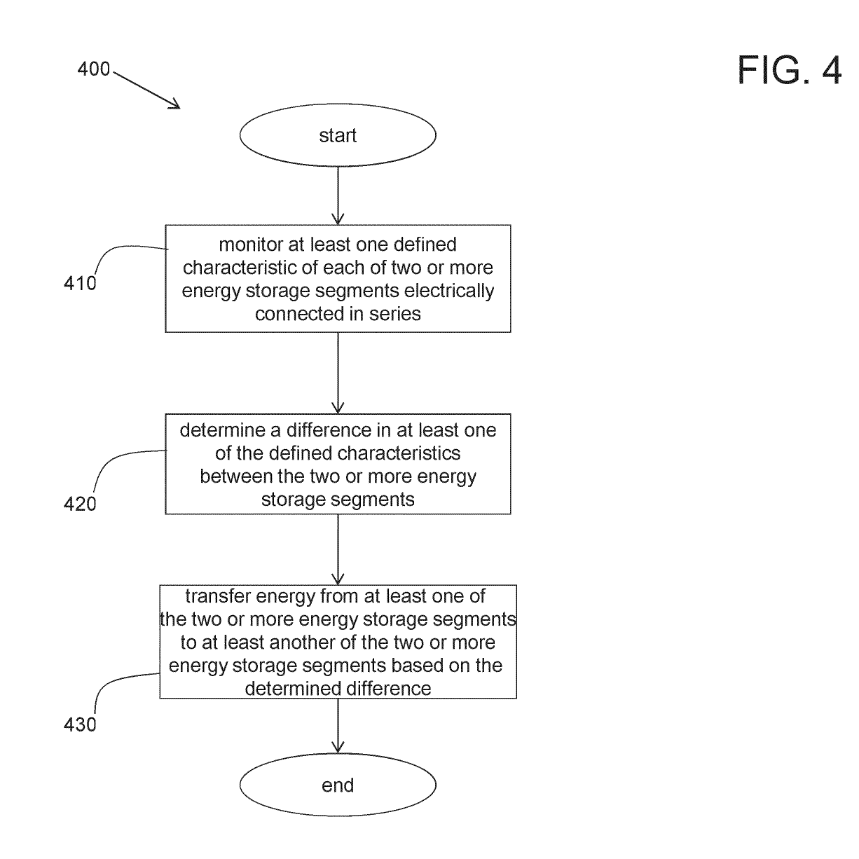

FIG. 4 is a flowchart of an exemplary embodiment of a method 400 of transferring energy between segments of energy storage elements using, for example, one of the systems 100, 200, or 300 of FIGS. 1-3. In step 410, at least one defined characteristic of each of two or more energy storage segments electrically connected in series is monitored (e.g., using the monitoring device 160 or the BMS's 210 and 220). Again, a defined characteristic may include a state-of-charge (SOC), a state-of-resistance (SOR), a state-of-energy (SOE), an energy, a capacity, a temperature, a voltage, and/or a current of each of the energy storage segments.

In step 420, a difference in at least one of the defined characteristics between the two or more energy storage segments is determined. For example, the determined difference may be made by the control device 150. In step 430, energy is transferred from at least one of the two or more energy storage segments to at least another of the two or more energy storage segments based on the determined difference. For example, the control device 150 provides control command signals to the balancing circuit 140 or 320 to accomplish the energy transfer based on the determined difference.

The term “determined difference” is used broadly herein to mean a determined relationship of a defined characteristic of the two or more energy storage segments. For example, the determined difference can be an actual difference derived by subtracting the defined characteristic of one energy storage segment from that of another. As another example, the determined difference can be a ratio of the defined characteristic of one energy storage segment and another. Other determined relationships are possible as well, in accordance with various other embodiments of the present invention.

Defined completion criteria for the energy transfer process can be of several types. For example, the control device 150 may be configured to command ceasing of the transferring of energy from one energy storage segment to another when two or more energy storage segments become balanced with respect to a defined characteristic. Similarly, the control device 150 may be configured to command ceasing of the transferring of energy from one energy storage segment to another when the determined difference becomes less than a predefined threshold value.

Furthermore, a time period of energy transfer may be estimated by the control device 150 based on the determined difference. The control device 150 may be configured to command ceasing of the transferring of energy from one energy storage segment to another when the time period has elapsed. Alternatively, the control device 150 may estimate an energy transfer rate based on the determined difference. The control device 150 may be configured to command ceasing of the transferring of energy from one energy storage segment to another when a defined amount of energy has been transferred as determined based on the energy transfer rate.

As an example, it may be desirable to balance the state-of-charge (SOC) of one energy storage segment with the SOC of another energy storage segment. Referring to FIG. 1, if the SOC of the first energy storage segment 120 is 90% and the SOC of the second energy storage segment 130 is 70%, it may be desirable to transfer energy from the first energy storage segment 120 to the second energy storage segment 130 as described herein to balance the SOC of each energy storage segment at, for example, 80%.

As another example, it may be desirable to balance the capacity of one energy storage segment with the capacity of another energy storage segment. Capacity refers to the total energy presently available from an energy storage segment. If a present capacity of the second energy storage segment 130 is 1000 kilowatt-hours and the capacity of the first energy storage segment 120 is 500 kilowatt-hours, it may be desirable to transfer energy from the second energy storage segment 130 to the first energy storage segment 120 as described herein to balance the capacity of each energy storage segment at, for example, 750 kilowatt-hours effective over the period of use.

Furthermore, knowledge of an excitation mode of the system may be used by the control device 150, along with the determined difference, to decide how energy should be transferred within the system. For example, voltages of two or more energy storage segments may be monitored during a known excitation mode (e.g., charging or discharging) and may be used by the control device 150, for example, in combination with at least one other defined characteristic to decide how energy should be transferred.

The excitation mode of the system may be a charge depleting mode, where the energy storage segments provide energy to a load until the energy storage segments are completely discharged (depleted). In a charge depleting mode, it may be desirable to transfer energy between the energy storage segments during operation such that all energy storage segments become depleted (fully discharged) at about the same time.

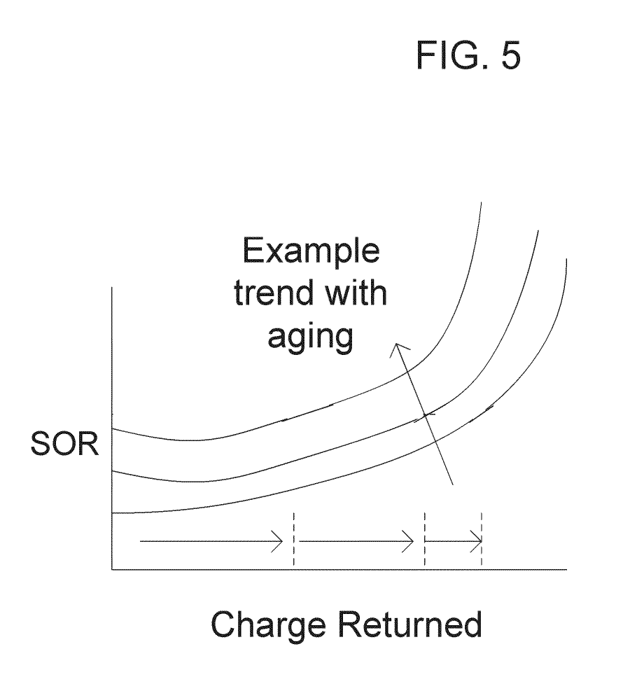

Alternatively, the excitation mode of the system may be a charge sustaining mode (e.g., a partial state of charge, PSOC, mode), where the energy storage segments are periodically partially discharged and recharged over a defined state-of-charge window as in, for example, a hybrid generator-battery power system. FIG. 5 provides a graph illustrating how the recharge state of resistance (SOR) of an energy storage segment may change as a function of charge returned, as well as age, of an energy storage segment.

In general, when an energy storage segment is in a low state-of-charge (SOC), the state-or-resistance (SOR) or recharge resistance is low, allowing the energy storage segment to build up charge (e.g., in a charge sustaining mode) relatively quickly for a given applied charging voltage (potential). However, as the charge returned builds up in the energy storage segment, the recharge resistance of the energy storage segment increases and the rate of charging slows down, for the given applied charging voltage. Furthermore, as an energy storage segment ages, the entire curve of SOR vs. charge returned tends to shift upward. As a result, the SOR ends up affecting the time it takes to recharge an energy storage segment.

In particular, for sodium metal halide type batteries, the curve representing SOR vs. charge returned can be quite dynamic due to the nature of sodium metal halide type batteries. In accordance with various embodiments, the metal in a sodium metal halide type of battery may be one or more of iron, nickel, zinc, and copper. The halide may be chloride, for example. In general sodium metal halide type of batteries provide a first-in/first-out type of operation. For example, as a sodium ion is passed into the cathode mix, the sodium ion finds the first site it can possibly bind to and proceeds to bind. As a result, recharging resistance of a sodium metal halide type of battery tends to have periods of low resistance following a discharge event where sodium ions have left vacancies close to the separator between cathode and anode.

The SOR vs. charge returned to an energy storage segment may be of keen interest, as this highly effects time on recharge. Observing the recharge resistance profile will inform the control device 150 of the best or most desirable charge window for each energy storage segment. In this application, it is often the case that an energy storage segment is operated over a small region of its total charge window. This is called partial state of charge (PSOC) operation. If the recharge resistance characteristic suggests that a smaller charge state window is warranted, the balancing circuit can be controlled to keep an energy storage segment operating within the proper PSOC band by transferring energy from another energy storage segment if warranted.

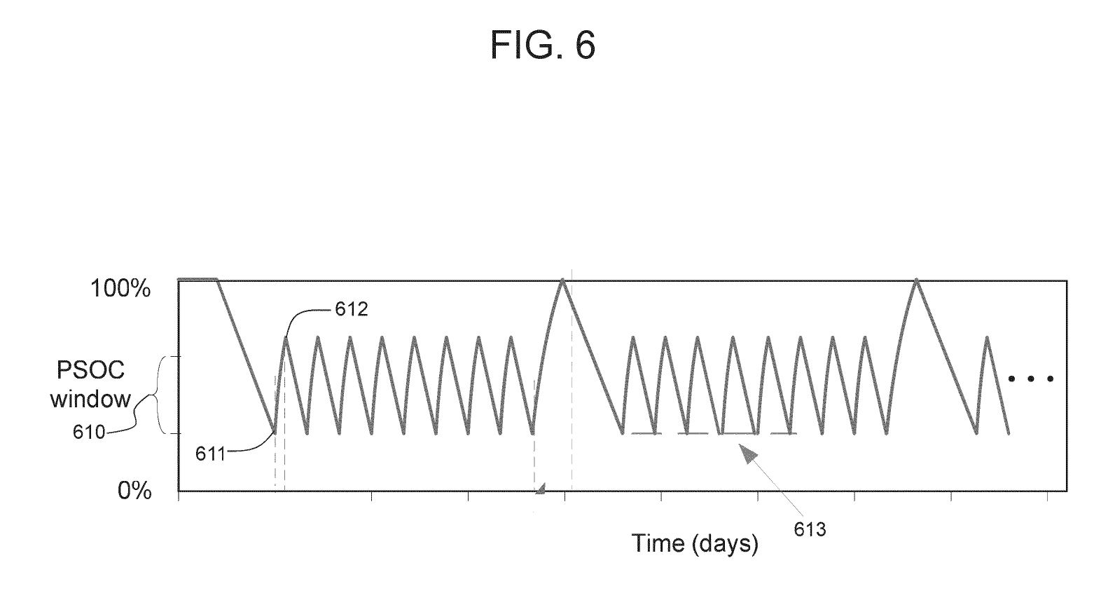

FIG. 6 provides a graph illustrating an exemplary embodiment of a cyclical charge sustaining methodology for a system (e.g., 300), having energy storage segments (e.g., 120, 130, and 310), based on the recharge state-of-resistance (SOR) characteristics of FIG. 5. For example, the energy storage segment 120 may be operated over the PSOC window 610, as shown in FIG. 6, cycling between a lower setpoint 611 and an upper setpoint 612 over time. At setpoint 611, the energy storage segment 120 has discharged to a lower state-of-charge (SOC) level 613 after supplying power to, for example, the DC load 115. The state-of-charge (SOC) of the energy storage segment 120 is determined by the control device 150 based on current feedback from the energy storage segment 120 to the control device 150 via the monitoring device 160. In general, the SOC can be estimated by the control device 150 by determining the current going into and out of the energy storage segment 120. This can be done by implementing a charge counter functionality in the control device 150 that effectively counts charge in units of, for example, amp-hours.

The setpoint 611 defines the lower limit of the PSOC window 610 and is an indicator to the control device 150 to start transferring charge from another energy storage segment (e.g., 130 and/or 310) to keep the SOC of the energy storage segment 120 within the PSOC window 610, if possible. This assumes that at least one of the other energy storage segments has energy to spare which can be transferred without, for example, dropping below a similar PSOC window for the other energy storage segment 130. If not, then the charging energy may be obtained from another source such as, for example, a generator when the system 300 is part of a hybrid generator-battery power system.

Another embodiment relates to a system, e.g., a system for controlling energy storage devices. The system comprises a control device that is configured to receive signals from at least one monitoring device operably connected to first and second energy storage devices. The signals relate to monitored operating parameters of the first and second energy storage devices (e.g., first and second cells of a battery). “Operating parameter” refers to a defined/selected characteristic of an energy storage device in operation. The control device is further configured to determine a difference between the monitored operating parameters of the first and second energy storage devices, e.g., the difference may be between the monitored operating parameter of the first energy storage device and the equivalent monitored operating parameter of the second energy storage device. The control device is further configured to generate one or more control signals based on the difference for controlling a balancing circuit to transfer energy from the first energy storage device to the second energy storage device (or vice versa). As examples, the operating parameters may comprise one or more of a state-of-charge (SOC), a state-of-resistance (SOR), a state-of-energy (SOE), a charge capacity, or an energy capacity of the first and second energy storage devices. In another embodiment, the control device is further configured to generate the one or more control signals based on an excitation mode of the first and second energy storage devices.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method of operating an energy storage system, comprising:
monitoring at least one defined characteristic of each of two or more energy storage segments electrically connected in series;
determining a difference in at least one of the defined characteristics between the two or more energy storage segments; and
transferring energy from at least one of the two or more energy storage segments to at least another of the two or more energy storage segments based on the determined difference.

2. The method according to claim 1, wherein the at least one defined characteristic comprises one or more of a state-of-charge (SOC), a state-of-resistance (SOR), a state-of-energy (SOE), a charge capacity, or an energy capacity.

3. The method according to claim 1, further comprising determining an excitation mode of the one or more energy storage segments, wherein the transferring of energy is further based on the determined excitation mode.

4. The method according to claim 3, wherein the excitation mode includes at least one of a charge depleting mode or a charge sustaining mode.

5. The method according to claim 1, further comprising monitoring a temperature of each of the two or more energy storage segments, wherein the transferring of energy is further based on the monitored temperature of each of the two or more energy storage segments.

6. The method according to claim 1, further comprising monitoring a voltage, during an excitation mode, of each of the two or more energy storage segments, wherein the transferring of energy is further based on the monitored voltage of each of the two or more energy storage segments.

7. The method according to claim 1, further comprising ceasing the transferring of energy when the determined difference becomes less than a predefined threshold value.

8. The method according to claim 1, further comprising ceasing the transferring of energy when one of the two or more energy storage segments and another of the two or more energy storage segments become balanced with respect to the at least one defined characteristic.

9. The method according to claim 1, further comprising estimating a time period of energy transfer based on at least the determined difference, and ceasing the transferring of energy when the time period has elapsed.

10. The method according to claim 1, further comprising estimating an energy transfer rate based on at least the determined difference, and ceasing the transferring of energy when a defined amount of energy has been transferred as determined based on the energy transfer rate.

11. A system, comprising:
two or more energy storage segments electrically connected in series;
at least one monitoring device configured to monitor at least one defined characteristic of each of the two or more energy storage segments;
at least one control device operatively connected to the at least one monitoring device and configured to generate at least one control signal representative of a determined difference in at least one of the defined characteristics between the two or more energy storage segments; and
at least one balancing circuit operatively connected to the at least one control device and the two or more energy storage segments and configured to transfer energy from at least one of the two or more energy storage segments to at least another of the two or more energy storage segments in response to the at least one control signal.

12. The system according to claim 11, wherein the at least one defined characteristic comprises one or more of a state-of-charge (SOC), a state-of-resistance (SOR), a state-of-energy (SOE), a charge capacity, or an energy capacity.

13. The system according to claim 11, wherein the at least one control device is further configured to generate the at least one control signal further based on an excitation mode of the one or more energy storage segments.

14. The system according to claim 13, wherein the excitation mode includes at least one of a charge depleting mode or a charge sustaining mode.

15. The system according to claim 11, wherein the at least one monitoring device comprises at least one temperature monitoring device configured to monitor a temperature of each of the two or more energy storage segments, wherein the at least one control device is operatively connected to the at least one temperature monitoring device and is further configured to generate the at least one control signal further based on the monitored temperature of each of the two or more energy storage segments.

16. The system according to claim 11, wherein the at least one monitoring device comprises at least one voltage monitoring device configured to monitor a voltage of each of the two or more energy storage segments during an excitation mode, wherein the at least one control device is operatively connected to the at least one voltage monitoring device and is further configured to generate the at least one control signal further based on the monitored voltage of each of the two or more energy storage segments.

17. The system according to claim 11, wherein the at least one control device is further configured to modify the at least one control signal to the at least one balancing circuit to cease the transferring of energy when the determined difference becomes less than a predefined threshold value.

18. The system according to claim 11, wherein the at least one control device is further configured to modify the at least one control signal to the at least one balancing circuit to cease the transferring of energy when one of the two or more energy storage segments and another of the two or more energy storage segments become balanced with respect to the at least one defined characteristic.

19. The system according to claim 11, wherein the at least one control device is further configured to estimate a time period of energy transfer based on at least the determined difference, and modify the at least one control signal to the at least one balancing circuit to cease the transferring of energy when the time period has elapsed.

20. The system according to claim 11, wherein the at least one control device is further configured to estimate an energy transfer rate based on at least the determined difference, and modify the at least one control signal to the at least one balancing circuit to cease the transferring of energy when a defined amount of energy has been transferred as determined based on the energy transfer rate.

21. The system according to claim 11, wherein:
the at least one of the two or more energy storage segments is electrically connected between a first bus and an intermediate bus, and the at least another of the two or more energy storage segments is electrically connected between the intermediate bus and a second bus; and
the balancing circuit comprises:
an inductor having a first terminal and a second terminal, the second terminal electrically connected to the intermediate bus;
a first switch electrically connected between the first bus and the first terminal of the inductor;
a second switch electrically connected between the first terminal of the inductor and the second bus;
a first diode connected between the first terminal of the inductor and the first bus;
a second diode connected between the first terminal of the inductor and the second bus; and
a control signal manager operably coupled to the first and second switches and to the control device, wherein the control signal manager is configured to control the switches, responsive to the at least one control signal, to transfer the energy.

22. A system, comprising:
a control device configured to receive signals from at least one monitoring device operably connected to first and second energy storage devices, the signals relating to monitored operating parameters of the first and second energy storage devices;
wherein the control device is further configured to determine a difference between the monitored operating parameters of the first and second energy storage devices and generate one or more control signals based on the difference for controlling a balancing circuit to transfer energy from the first energy storage device to the second energy storage device.

23. The system according to claim 22, wherein the operating parameters comprise one or more of a state-of-charge (SOC), a state-of-resistance (SOR), a state-of-energy (SOE), a charge capacity, or an energy capacity of the first and second energy storage devices.

24. The system according to claim 22, wherein the control device is further configured to generate the one or more control signals based on an excitation mode of the first and second energy storage devices.
